(19) United States
(12) Patent Application Publication
(10) Pub. No.: US 2007/0240342 A1
(43) Pub. Date: Oct. 18, 2007

(54) Capsule

(76) Inventor: David Stewart Cowley, Bath (GB)

Correspondence Address: SMITH-HILL AND BEDELL, P.C., 16100 NW CORNELL ROAD, SUITE 220, BEAVERTON, OR, 97006, US

(21) Appl. No.: 11/286,716

(22) Filed: Nov. 25, 2005

(30) Foreign Application Priority Data
Nov. 24, 2004 (GB) 0425788.7
Apr. 13, 2005 (GB) 0507409.1

(51) Int. Cl. G09F 19/00

(52) U.S. Cl. 40/406

(57) ABSTRACT

A capsule comprises a liquid and a liquid encapsulating member encapsulating the liquid. The encapsulating member comprises a light transmissive encapsulating portion to encapsulate the liquid and securing means on the encapsulating portion to secure the capsule to a support.

This invention relates to capsules. More particularly, but not exclusively, the invention relates to support arrangements incorporating such capsules. This support arrangements may comprise covers, for example covers for books.

Covers for books, particularly books for younger children, generally comprise pictures which do little to enhance the child's tactile senses.

According to one aspect of this invention, there is provided a capsule comprising a fluid, and a fluid encapsulating member encapsulating the fluid, wherein the fluid encapsulating member comprises a light transmissive encapsulating portion to encapsulate the fluid, and securing means on the encapsulating portion to secure the capsule to a support arrangement.

The fluid is preferably a liquid.

Preferably, the encapsulating portion is transparent.

In a first embodiment, the securing means may comprise a securing portion. The securing portion may extend from the encapsulating portion.

Preferably, the securing portion comprises a web extending from the encapsulating member. In the first embodiment, the web may comprise a flange extending outwardly around the encapsulating member. In a second embodiment, the web may comprise a bridge extending inwardly of the encapsulating member.

In the second embodiment, the encapsulating member may comprise a frame adapted to be arranged around the support. Preferably, in the second embodiment, the encapsulating member may define a central space across which the bridge may extend.

In the first embodiment, the securing portion may extend around, preferably substantially wholly around the encapsulating member. The securing portion may be light transmissive.

The encapsulating member may be formed of a flexible material, preferably a flexible plastics material, such as vinyl. The securing portion may be formed of a flexible material, preferably a flexible plastics material, such as vinyl. The securing portion and the encapsulating member may be formed integrally with each other.

The encapsulating member may comprise a plurality of compartments, which may be adjacent one another. The compartments may be separated from one another by walls. The walls may be formed of substantially the same material as the encapsulating member. This provides an advantage in the preferred embodiment that different regions of the capsule can be of a different colour and/or shape without affecting other regions.

A stiffening member may be provided on the encapsulating member to provide rigidity to the encapsulating member. The stiffening member may extend across the encapsulating member. Preferably, the stiffening member extends across the encapsulating portion and across the securing portion. Preferably, the encapsulating member has a face which may be generally planar.

Preferably, the face extends across the encapsulating member and the securing portion. The stiffening member may be provided on the face and may extend wholly across the face. Preferably, the stiffening member extends outwardly from the encapsulating member and may extend substantially wholly around the encapsulating member.

The stiffening member may comprise a substantially flat sheet, and may be formed of an acetate material. The stiffening member may be light transmissive. Display means may be provided on the encapsulating portion, or on the stiffening member. The display means may comprise printing on the encapsulating portion or on the stiffening member, conveniently on the inner surface of the encapsulating portion, or on the stiffening member. In the preferred embodiment, the stiffening member provides the advantage that it prevents or restricts flexing of the capsule.

The fluid may be coloured. Each compartment may hold a fluid. The fluid in each compartment may be of a different colour to the fluid in at least one other compartment. The fluid may be any suitable fluid, such as a low viscosity, non-toxic oil. The fluid may be baby oil, or may be similar to baby oil. The encapsulating member may include decorative elements thereon. The decorative elements may comprise a decorated face of the encapsulating member.

Preferably, the decorative elements comprise a plurality of decorated faces of the encapsulating member. The decorative faces may be arranged to provide a desired pattern.

The decorative elements may comprise printing. The printing may be provided on the inner surface of the encapsulating member. Different decorative elements which may be of different colours, may be printed on the inner surface of the encapsulating member. Preferably, the aforesaid inner surface is opposite the securing means. Where the capsule comprises a stiffening member, the printing may be on the surface facing the stiffening member.

Thus, in the preferred embodiment, each compartment can be provided with a different decorative element to the others, and may also be provided with a different coloured fluid therein. The decorative elements of different compartments can, in the preferred embodiment, be of different colours. The feature of the decorative elements being printed on the inner surface of the encapsulating member provides the advantage, in the preferred embodiment, that the decorative elements cannot be scratched off during normal use.

According to another aspect of this invention, there is provided a support assembly comprising a capsule as described above, and a support arrangement configured to receive the securing portion of the capsule.

The support assembly may comprise a cover such as a cover for a book.

In one embodiment, the support arrangement may comprise a formation to receive the capsule. The formation may be in the form of an aperture in which the capsule is arranged. Preferably, the support arrangement defines a recess extending from the capsule to receive the securing means of the capsule.

The support arrangement may comprise a plurality of support members, which may be arranged upon one another. The support arrangement may comprise an inner and outer support member, which may include holding portions to hold the aforesaid securing portion of the encapsulating member. Preferably, the holding portions comprise inner edge regions of the aforesaid inner and outer support members that extend over the securing portion.

The support arrangement may comprise at least one spacer member arranged between the inner and outer support members to space the inner and outer support members from one another. Preferably, the support arrangement comprises a pair of spacers, which may be arranged one upon the other.

The stiffening member may be received in the recess. The inner support member may include a shoulder extending around the aperture. The stiffening member may abut against the shoulder.

In a second embodiment, the capsule may extend around the support arrangement, and may comprise a frame for the support arrangement.

In this embodiment, the capsule defines an aperture and the securing means comprises a bridge extending across the aperture. Preferably, the support arrangement comprises a flap formation to cooperate with the bridge. The flap formation may comprise a flap portion, which may be part of a cover of a book, or other article.

Attachment means may be provided to attach the support assembly to a carrier. The attachment means may comprise a sucker mounted on the capsule.

A stand member may be provided to allow the support assembly to stand in an upright condition. The stand member may comprise an easel formation hingedly attached to the support arrangement.

In a third embodiment, the capsule may not have a stiffening member capable of transmitting light therethrough. The encapsulating member may be mounted on the support arrangement. The support arrangement may extend beneath the encapsulating member. In this embodiment, the support arrangement may be devoid of the aforesaid aperture. The encapsulating member may be mounted on the support arrangement by a suitable adhesive. In these embodiments, the securing portion may constitute a rear face of the encapsulating portion.

Embodiments of the invention will now be described by way of example only, with reference to the accompanying drawings in which

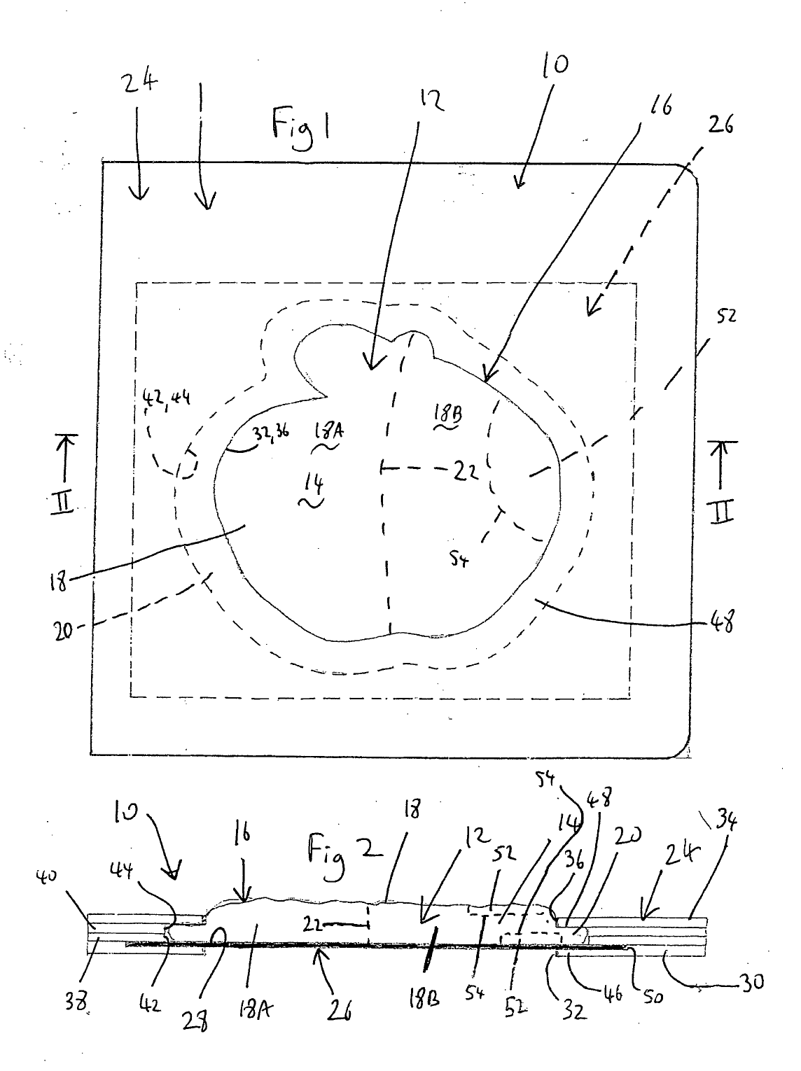

FIG. 1 is a top plan view of a support arrangement incorporating a capsule; and

FIG. 2 is a view along the lines II-II in FIG. 1;

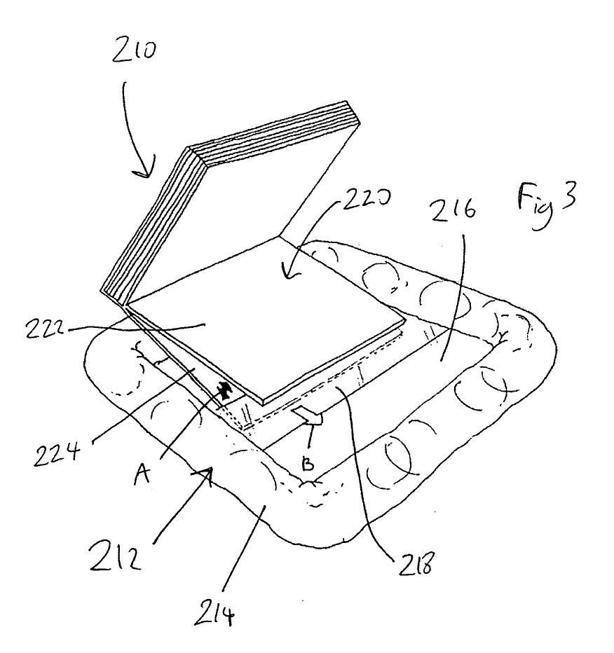

FIG. 3 shows a diagrammatic representation of a second embodiment showing a support arrangement being secured to the capsules;

FIG. 4 is a top view of the capsule and the support arrangement shown in FIG. 3;

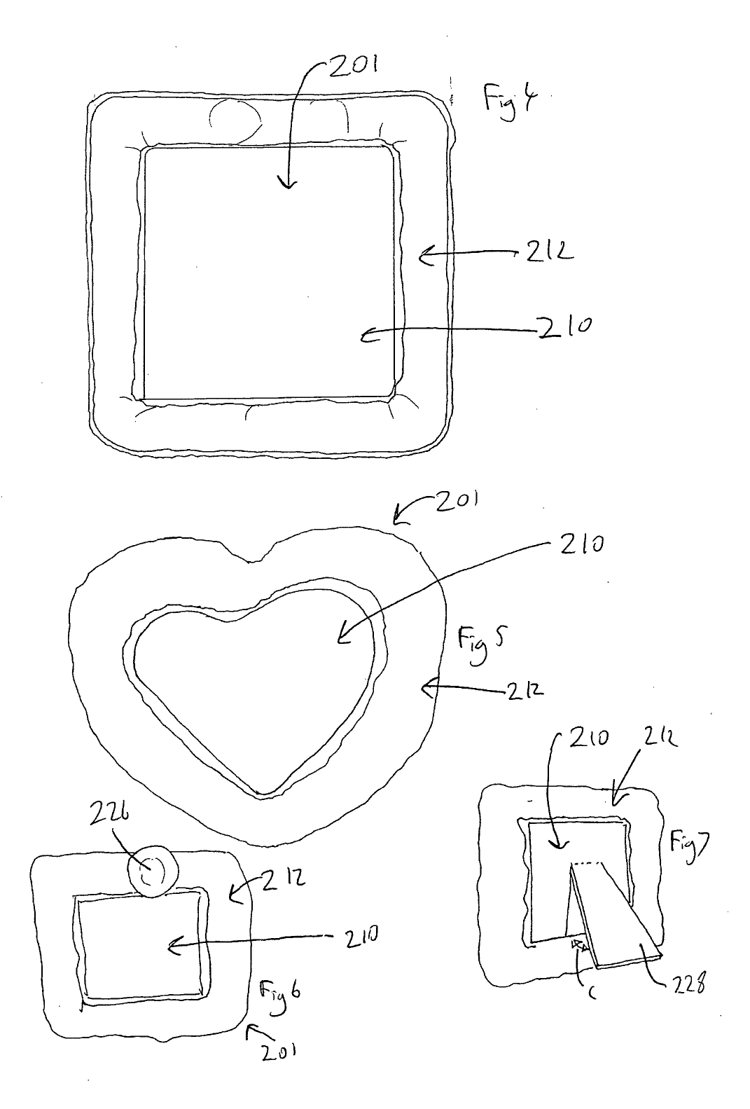

FIG. 5 is a top view of another version of the capsule and support arrangement shown in FIG. 4, but of a different shape;

FIG. 6 is a rear view of a capsule showing an attachment means;

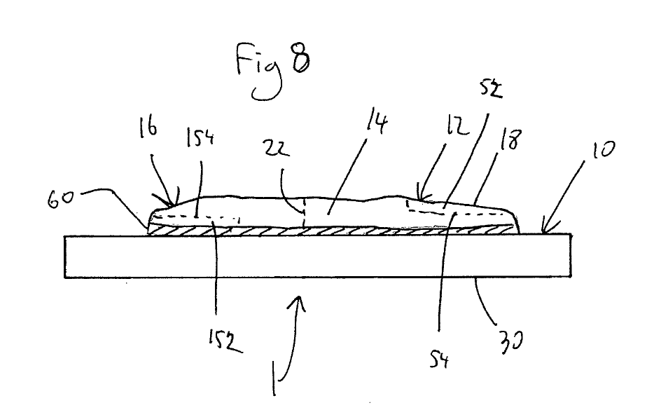

FIG. 7 is a perspective rear view of a capsule and support arrangement showing a stand member;

FIG. 8 is a view similar to FIG. 2 of another embodiment.

Referring to FIGS. 1 and 2 of the drawings, there is shown a support assembly 1 in the form of a cover for a children's book. The support assembly 1 comprises a support arrangement 10 incorporating a capsule 12.

The capsule 12 comprises a fluid in the form of a liquid 14 encapsulated by an encapsulating member 16. The liquid comprises a low viscosity, non-toxic oil such as baby oil or the like.

The encapsulating member 16 comprises an encapsulating portion 18 in which the liquid 14 is held, and a securing portion 20 (see FIG. 2) extending from the encapsulating portion 18. The securing portion 20 is in the form of a flange and extends wholly around the encapsulating portion 18.

Although FIG. 2 shows that the liquid 14 extends into the securing portion 20 from the encapsulating portion 18, it will be appreciated that the securing portion 20 could be sealed off from the encapsulating portion 18.

The encapsulating member 16 is formed of a suitable light transmissive, flexible plastics material, such as vinyl. The liquid 14 may contain colouring or dyeing agents.

The encapsulating portion 18 could, if desired, be divided into compartments, for example as shown by a wall 22, shown by the broken line dividing the encapsulating portion 18 into two compartments 18A, 18B. The liquid 14 in the different compartments may contain respective different colours or dyeing agents. Thus, different colour liquids could, if desired, be provided in each of the respective compartments 18A, 18B. It will be appreciated that any desired number of compartments can be provided by the provision of a suitable number and positions of walls 22.

The support arrangement 10 includes a laminated support 24 in which the capsule 12 is mounted. In order to prevent the capsule 12 from being dislodged from the laminate support 24, a stiffening member 26 in the form of a light transmissive sheet of acetate material is provided on an inner face 28 of the encapsulating member 12. As can be seen from FIG. 2, the inner face 28 is generally planar and extends across the encapsulating portion 18 and the securing portion 20.

The stiffening member 26 is generally rectangular in configuration, and extends beyond the securing portion 20 of the encapsulating member 12, to be received within the laminated support 24, as discussed below.

The laminated support 24 comprises an inner cover member 30 defining an aperture 32. The aperture 32 is defined to be generally the same size and shape as the encapsulating portion 16 of the encapsulating member 12. Similarly, the laminated support 24 comprises an outer cover member 34 defining an aperture 36 which is generally of the same size and shape as the aperture 32.

Between the inner and outer cover members 30, 34, there is provided two spacer members 38, 40 defining respectively apertures 42, 44. The apertures 42, 44 are larger than the apertures 32, 36 and are generally the same size and shape as the securing member 20. Thus, as can be seen from FIG. 2, the inner and outer cover members 30, 34 comprise respective inwardly extending holding portions 46, 48 which extend over the securing portion 20 of the encapsulating member 12, thereby sandwiching the securing portion 20 between the holding portions 46, 48.

The inner cover member 30 comprises a shoulder 50 against which the edge of the stiffening member 26 abuts, thereby holding the stiffening member 26 in position between the inner cover member 30 and the inner space 38.

There is thus described a cover member for a book in which a capsule 12 incorporating a liquid 14 is securably held.

FIGS. 3 to 7 show a further embodiment of the invention, in which it is designated 212 and is in the form of a frame 214 defining a simple space 216 and comprising securing means in the form of a bridge 218 extending across the central space 216 and attached to the frame 214 at regions opposite each other. The frame 214 comprises the features of the capsule 12 as described above. The bridge 218 is formed of a suitable plastics material, for example vinyl, integrally with the frame 214. In the embodiment shown, a support arrangement 210 in the form of a book comprises a rear cover 220 having first and second flap portions 222, 224. The first flap portions 222, 224 can be separated as shown by the arrow A and slid across the bridge 218 as shown by the arrow B, such that the bridge 218 is received between the first and second flap portions 222, 224, and until the support arrangement 210 is in the position shown in FIG. 4 i.e. centrally received within the central space 216. When the support arrangement is in this position, the first and second flap portion 222, 224 can be glued together to securely hold the bridge 216 therebetween, thereby securing the support arrangement 10 to the capsule 212.

FIG. 4 shows a top view of a support assembly 201 provided by the support arrangement 210 and capsule 212 shown in FIG. 3. As can be seen, the capsule 212 provides a frame around the book of the support arrangement 210. In FIG. 4, the capsule 212 is of a substantially square configuration.

A further version of the embodiment shown in FIG. 4 is shown in FIG. 5 in which the book of the support arrangement 212 is of a heart shape, and the capsule 212 is also of a heart shape. It will be appreciated that the capsule and the book can be of any desired shape.

Referring to FIG. 6, there is shown one version of the rear of the support arrangement 201 shown in FIG. 6, in which attachment means, in the form of a plastics sucker 226 is provided to secure the support arrangement 210 to a suitable carrier, for example a wall.

FIG. 7 shows a rear view of an alternative version, in which the support arrangement 210 is provided with an easel member 228 hingedly attached to the support arrangement 210 for movement as shown by the arrow C, to support the support assembly 201 in an upright condition on a generally horizontal surface.

A third embodiment is shown in FIG. 3. This embodiment includes many of the same features shown in FIG. 2, and these have been designated with the same reference numerals.

In this embodiment, the support arrangement 10 comprises a single cover member 30, which does not have the aperture 32. In this embodiment, there is no requirement for light to be transmitted through the support arrangement 10.

The encapsulating member 16 is secured to the cover member 30 by an adhesive 60. The use of the adhesive 60 means that the securing portion 20 is not needed and is omitted. Similarly, the encapsulating member 16 is provided with the necessary rigidity by the cover member 30 and, hence, the stiffening member 26 is not needed and is omitted.

If desired, the encapsulating member 16 could include decorative regions 52 on the inner surface of the encapsulating member 16.

Various modifications can be made without departing from the scope of the invention. For example, the capsule 12 can be of any desired shape, for example, the shape of a car. The capsule 12 could include display means, in the form of decorative regions 52 as indicated by the broken line 54 in the drawings, in which a coloured ink is printed onto the inner surface of the plastic material forming the encapsulating portion 18, thereby providing a desired decorative effect. Alternatively, or in addition, the decorative regions could be provided on the stiffening member 26, as shown.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. A capsule comprising a fluid, and a fluid encapsulating member encapsulating the fluid, wherein the fluid encapsulating member comprises a light transmissive encapsulating portion to encapsulate the fluid, and securing means on the encapsulating portion to secure the capsule to a support arrangement.

2. A capsule according to claim 1 wherein the encapsulating portion is transparent and the securing means comprises a securing portion extending from the encapsulating portion.

3. A capsule according to claim 2 wherein the securing portion comprises a web extending from the encapsulating member, the web comprising one or more flanges extending outwardly around the encapsulating members and a bridge extending inwardly of the encapsulating member, and the encapsulating member comprises a frame adapted to be arranged around the support, the frame defining a central space across which the bridge extends.

4. A capsule according to claim 2 wherein the securing portion comprises a web extending from the encapsulating member, the web comprising one or more flanges extending outwardly around the encapsulating member and a bridge extending inwardly of the encapsulating member, and the securing portion extends substantially wholly around the encapsulating member.

5. A capsule according to claim 1 wherein the encapsulating member is formed of a flexible material, and the securing means is formed of a flexible material.

6. A capsule according to claim 1, wherein the encapsulating member comprises a plurality of compartments, and each compartment is separated from the, or each, adjacent compartment by inner walls, each compartment holding a liquid, and the liquid in each compartment being of a different colour to the liquid in other compartments.

7. A capsule according to claim 1 wherein the encapsulating member includes decorative elements thereon, the decorative elements comprising a decorated inner face of an outer skin of the encapsulating member.

8. A capsule according to claim 1 wherein a stiffening member is provided on the encapsulating member to provide rigidity to the encapsulating member, the stiffening member extending across the encapsulating member.

9. A capsule according to claim 8 wherein the stiffening member extends across the encapsulating portion and across the securing means.

10. A capsule according to claim 8 wherein the encapsulating member has a face which is generally planar, the face extending across the encapsulating member and the securing portion, and the stiffening member is provided on the face and extends wholly across the face, and the stiffening member extends outwardly from the encapsulating member and extends substantially wholly around the encapsulating member.

11. A capsule according to claim 8 wherein display means is provided on the encapsulating portion and/or on the stiffening member.

12. A support assembly comprising a capsule as claimed in claim 1 and a support arrangement configured to receive the securing portion of the capsule.

13. A support assembly according to claim 12 wherein the support arrangement comprises a formation to receive the capsule, the formation being in the form of an aperture in which the capsule is arranged.

14. A support assembly according to claim 13 wherein the support arrangement defines a recess extending from the capsule to receive the securing means of the capsule.

16. A support assembly according to claim 12 wherein the support arrangement comprises a plurality of support members, arranged upon one another, including an inner and outer support member, each of said inner and outer support member having holding portions to hold the aforesaid securing portion of the encapsulating member.

17. A support assembly according to claim 16 wherein the holding portions comprise inner edge regions of the aforesaid inner and outer support members that extend over the securing portion.

18. A support assembly according to claim 16 wherein the support arrangement comprises at least one spacer member arranged between the inner and outer support members to space the inner and outer support members from one another.

19. A support assembly according to claim 16 including a stiffening member, the stiffening member being received in the recess, and the inner support member including a shoulder extending around the aperture, wherein the stiffening member abuts against the shoulder.

20. A support assembly according to claim 12 wherein the capsule extends around the support arrangement, and constitutes a frame for the support arrangement.

21. A support assembly according to claim 23 wherein the capsule defines an aperture, the securing means comprises a bridge extending across the aperture, and the support arrangement comprises a flap formation to cooperate with the bridge.

22. A support assembly according to claims 20 wherein attachment means is provided to attach the support assembly to a carrier.

23. A support assembly according to claim 22 wherein the attachment means comprises a sucker mounted on the capsule.

24. A support assembly according to claim 20 wherein a stand member is provided to allow the support assembly to stand in an upright condition.

25. A support assembly according to claim 24 wherein the stand member comprises an easel formation hingedly attached to the support arrangement.

26. A support assembly according to claim 20 wherein the capsule is substantially devoid of a stiffening member capable of transmitting light therethrough, the encapsulating member being mounted on the support arrangement, and the support arrangement extending beneath the encapsulating member.

27. A support assembly according to claim 26 wherein the securing portion constitutes a rear face of the encapsulating portion.
